(19) United States
(12) Patent Application Publication
(10) Pub. No.: US 2026/0272736 A1
(43) Pub. Date: Sep. 17, 2026

(54) RIDER INCLUSIVE TRANSPORT AIDE

(71) Applicant: DISNEY ENTERPRISES, INC., Burbank, CA (US)

(72) Inventor: Kristopher M. Laffin, Long Beach, CA (US)

(21) Appl. No.: 19/076,060

(22) Filed: Mar. 11, 2025

(51) Int. Cl. A61G 3/06; A61G 3/08; A63G 31/00

(52) U.S. Cl. CPC A61G 3/061; A61G 3/0808; A63G 31/007

(57) ABSTRACT

A ride vehicle may include a platform configured to receive an object. In one example, the platform is configured to move in response to a tilting motion of the ride vehicle to transport the object on the moveable platform in a flat orientation with respect to a water or ground surface. In another example, the platform forms a load surface configured to receive an object, wherein the platform is configured to move in response to a movement of the vehicle to maintain the platform in a flat orientation with respect to a water or ground surface.

### FIELD

The present application relates generally to a ride system, such as rides or attractions with movable vehicles for carrying one or more passengers.

### BACKGROUND

It is desirable for rides or ride systems to be accessible to a variety of passengers, including passengers with disabilities. For example, ride vehicles may be configured to allow passengers with disabilities to experience a ride or attraction, such as allowing passengers using a wheelchair, scooter, or other mobility aide to drive their wheelchair or scooter onto the vehicle without needing to transfer out of the wheelchair or scooter (e.g., a rider inclusive transport aide). However, it is often difficult to load the wheelchair or scooter onto and off the ride vehicle. The space required to maneuver the wheelchair or scooter, including ramp angles, turn radii, and passthrough widths, also limits the size of vehicle that can accommodate the wheelchair or scooter. Special accommodations often need to be made, such as adding removable sections of the vehicle, doors, and/or complex platforms, which significantly decrease the reliability and increase the weight, complexity, and cost of the ride vehicle.

In addition, boat rides have additional limitations that further add to the difficulty in loading and unloading objects (e.g., wheelchairs or scooters). Typically, the sides of the boat (e.g., gunwales) need to be higher or taller than a typical ride vehicle, such as to ensure no water can intrude into the vehicle, while ensuring the center of gravity is low for stability. Additionally, doors are not typically used on boats for ingress/egress due to their inherent leak probability. This means that a wheelchair, scooter, or other object will typically need to load from a high point, above the boat gunwale, which leads to difficulties in the design of the loading platform, including long loading ramps, fall protection rails, etc. To ensure stability of the ride vehicle and/or the comfort of the passenger in a wheelchair or scooter, the wheelchair, scooter, or object needs to be placed as low as possible in the boat. This means there is a large change in height that needs to be accommodated when loading and unloading the wheelchair, scooter, or object. Since the ramp angle may be limited per design code, most boat rides use a mechanically actuated system that requires power to operate. However, most boat rides do not have power onboard, such as due to the complexity of getting power across the hull without creating a leak prone penetration. Such difficulties create complex, expensive systems that typically do not meet longevity requirements and lead to frequent and costly downtimes and repairs.

Therefore, a need exists for systems and methods that address the concerns above.

### BRIEF SUMMARY

In one example, a ride vehicle includes a movable platform configured to receive an object, wherein the movable platform is configured to move in response to a tilting motion of the ride vehicle to transport the object on the moveable platform in a flat orientation with respect to a water or ground surface.

Optionally, the ride vehicle includes a curved surface, wherein the movable platform is configured to move along the curved surface in response to the tilting motion of the ride vehicle. The movable platform may include a planar surface, wherein the curved surface is configured to maintain the planar surface in the flat orientation during the tilting motion of the ride vehicle.

Optionally, the tilting motion is configured to move the movable platform between a loading/unloading position and a ride position. The loading/unloading position may be configured to locate the movable platform adjacent a loading/unloading platform for moving the object on and off the movable platform. The ride position may be configured to locate the movable platform and the object thereon within the ride vehicle. The movable platform may be releasably secured in the ride position. The ride vehicle may include one or more seats, wherein the ride position is configured to locate the movable platform to cause the object to be level with the one or more seats.

Optionally, the ride vehicle is configured to move in a ride direction, wherein the tilting motion is a tilting of the ride vehicle at least one of forwardly or rearwardly relative to the ride direction.

Optionally, the movable platform includes securement features configured to engage the object to secure the object on the movable platform.

Optionally, the object is a wheelchair, an electric scooter, or a stroller.

Optionally, the ride vehicle is a water vehicle.

In another example, a vehicle includes a platform forming a load surface configured to receive an object, wherein the platform is configured to move in response to a movement of the vehicle to maintain the platform in a flat orientation with respect to a water or ground surface.

Optionally, the movement includes a pitching of the vehicle about an axis. The platform may be configured to move linearly in response to the pitching of the vehicle.

Optionally, the vehicle includes fixed sides defining a ride compartment, wherein the platform is configured to move the object over at least one of the fixed sides and into the ride compartment in response to the movement of the vehicle.

Optionally, the vehicle includes a ramp and one or more wheels configured to move the platform along the ramp. The ramp may include a curved surface, wherein the one or more wheels are positioned to move along the curved surface.

Optionally, the platform is configured to move between a loading/unloading position and a ride position in response to the movement of the vehicle, wherein the platform is configured to move between the loading/unloading position and the ride position based on gravity. The vehicle may include a floor, wherein the ride position is configured to locate the object at or adjacent the floor. The loading/unloading position may be configured to bias the platform against a loading/unloading platform.

Optionally, the vehicle is a ride vehicle for an attraction.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates a cross-sectional view showing an example movable platform at a loading/unloading position.

FIG. 2 illustrates a cross-sectional view showing an example movable platform between loading/unloading and ride positions.

FIG. 3 illustrates a cross-sectional view showing an example movable platform at a ride position.

FIG. 4 illustrates an example ride vehicle at a loading/unloading platform.

FIG. 5 illustrates load rails of an example ride vehicle, with the ride vehicle at a horizontal or flat position.

FIG. 6 illustrates the ride vehicle of FIG. 5 tilted up for loading or unloading.

FIG. 7 illustrates an example ride vehicle in a first position and ready to receive a wheelchair or scooter at a loading/unloading platform.

FIG. 8 illustrates the ride vehicle of FIG. 7 in the first position and the wheelchair or scooter positioned on a movable platform.

FIG. 9 illustrates the ride vehicle of FIG. 7 tilting forward to a second position with the movable platform moving away from the loading/unloading platform.

FIG. 10 illustrates the ride vehicle of FIG. 7 tilted forward to a third position with the movable platform at a ride position.

### DETAILED DESCRIPTION

The disclosed systems provide a ride vehicle, such as a boat. The ride vehicle may include a hull with a bow, stern, and side gunwales. A ramp or track may be located inside the hull, such as sloping from the floor of the hull to the bow or stern wall of the hull. An onboard movable platform may be associated with the ramp or track and define a flat or planar surface. An object may sit on the flat or planar surface. The object may be a wheelchair, scooter, electric scooter, walker, stroller, prop, animatronic, maintenance cart or equipment, or another item, whether with or without wheels. The movable platform may move along the ramp or track, such as the platform including wheels that ride in, on, or along the ramp or track (e.g., to allow the platform to roll along the sloped ramp or track freely).

To load the object onto the platform, the ride vehicle may be rotated or tilted around a fixed point. For example, as the ride vehicle rotates towards its stern, the platform may roll along the ramp towards the stern of the vehicle. The motion of the platform may be attributed to gravity as the platform finds the lowest point of the ramp or track. The ramp or track may be circular, in which case the lowest point moves as the ride vehicle rotates around the fixed point. The platform may roll along the ramp or track until the platform meets (e.g., in both elevation and position) a loading/unloading platform adjacent the ride vehicle. After the ride vehicle is locked in place, the object may be loaded onto the platform. For example, a passenger in the wheelchair or scooter may load onto the platform.

Once the object is in place and secured on the platform, the ride vehicle may be rotated or tilted back, such as to a horizontal or flat position. This motion may shift the lowest point of the ramp or track forward again, allowing the platform, with the object secured thereto, into a forward, lower section of the hull while remaining horizontal or flat through the motion. Once the platform is lowered into the hull and into a correct position (e.g., biased against the bow of the ride vehicle or a stop), an operator may dispatch the ride vehicle into the normal ride path.

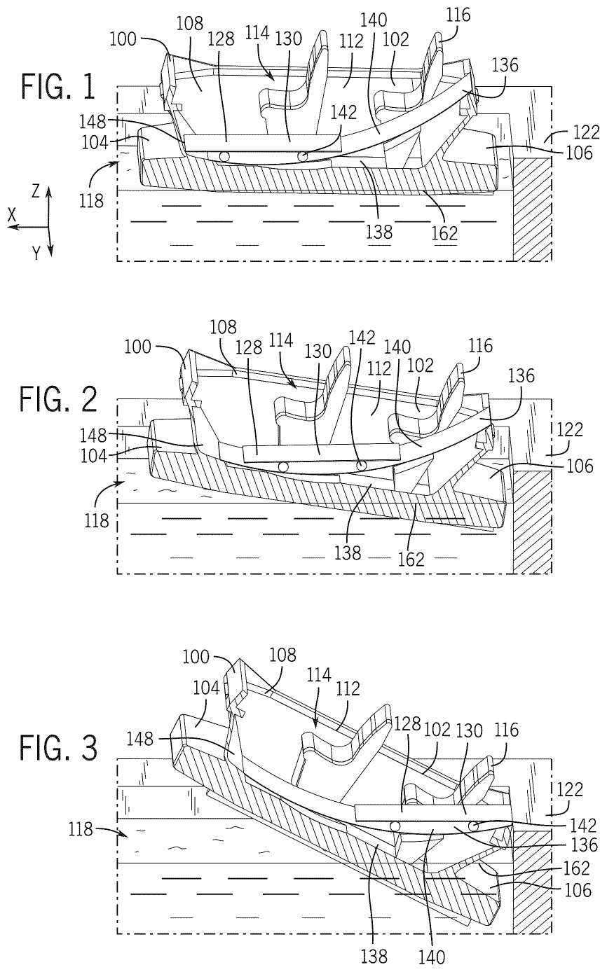

FIGS. 1-3 illustrate cross-sectional views of an example ride vehicle 100. The ride vehicle 100 is configured to carry one or more passengers, such as through an attraction or ride. For example, the ride vehicle 100 may include a hull 102 with a bow 104, a stern 106, and side gunwales 108, such as when implemented as a boat for a water ride or attraction. The ride vehicle 100 may have different configurations based on applicable restrictions, a ride or attraction theme, a desired passenger experience, or the like. For example, the ride vehicle 100 may include an open or closed cockpit, be sized and shaped to mimic a desired vehicle or theme (e.g., water vehicle, air vehicle, ground vehicle, movie vehicle, etc.), be realistic or unrealistic (e.g., imaginary), etc., but generally be configured to receive one or more passengers. For example, the hull 102 may be configured as a ride compartment 112 that includes a seating area 114 having one or more seats 116 allowing one or more passengers to sit comfortably within the ride vehicle 100. In other examples, the cockpit or ride compartment 112 may include a standing or other position configuration for the one or more passengers. Although terms are applied to a water vehicle, the ride vehicle 100 may be a non-water vehicle. In such examples, the bow 104 may refer to the front of the vehicle, the stern 106 may refer to the back of the vehicle, and the gunwales 108 may refer to the sides of the vehicle. Additionally, or alternatively, the disclosed features may be applicable to other vehicles, such that the ride vehicle 100 for an attraction is one implementation.

The ride vehicle 100 may be configured to traverse a pathway 118. The pathway 118 may be defined by a flume, a track, a ground surface, lifts and drops, belts, or the like, such as to move the ride vehicle 100 through the attraction from a beginning to an end (e.g., in a loop). The beginning may define or include an area allowing passengers to board the ride vehicle 100 (e.g., a loading zone, to load the ride vehicle 100), and the end may define or include an area allowing passengers to exit the ride vehicle 100 (e.g., an unloading zone, to unload the ride vehicle 100). In examples, the beginning and end of the pathway 118 may be defined at the same location or area, such as to allow the boarding and exiting of passengers simultaneously or near simultaneously, although other configurations are contemplated. For example, the attraction may include a loading/unloading platform 122. The loading/unloading platform 122 may be at the beginning and/or end of the pathway 118. In such examples, the ride vehicle 100 may be positioned adjacent the loading/unloading platform 122 for loading and unloading passengers or objects.

In examples, the ride vehicle 100 includes a platform 128 forming a load surface, such as to receive an object. The load surface may be a planar surface 130. The platform 128 may be movable to maintain an orientation of the planar surface 130. For example, the platform 128 may be configured to move in response to a movement of the ride vehicle 100, such as to maintain the platform 128 in a horizontal or flat orientation with respect to the water or ground surface (e.g., earth). For example, the ride vehicle 100 may roll left or right or tilt up and down, such as for passenger loading or unloading. FIG. 1 illustrates a Cartesian coordinate system of the ride vehicle 100, with the X-axis extending along the pathway 118 and the Z-axis extending vertically from the pathway 118. In one example, the ride vehicle 100 may roll about its longitudinal axis, such as about the X-axis. In another example, the ride vehicle 100 may pitch about its lateral or side-to-side axis, such as about the Y-axis. As the ride vehicle 100 rolls or tilts, the platform 128 may move in response, such as naturally or passively, in a manner maintaining the platform 128 or planar surface 130 in a horizontal or flat orientation, as detailed below.

The ride vehicle 100 may include a ramp 136. The ramp 136 may slope from a floor 138 of the hull 102 to a side wall (e.g., the bow or stern wall). In the implementation shown in FIGS. 1-3, the ramp 136 slopes towards the stern 106. The ramp 136, or portions thereof, may be linear or curved. As shown, the ramp 136 includes a curved surface 140, and the platform 128 may move along the curved surface 140 in response to the tilting motion of the ride vehicle 100. The curved surface 140 may be configured to maintain the planar surface 130 in a horizontal or flat orientation during the tilting motion of the ride vehicle 100. For example, the platform 128 may include one or more wheels 142 or rollers configured to move the platform 128 along the ramp 136. In another example, the ramp 136 may include the wheels 142 or rollers. The wheels 142 may be positioned to move along the curved surface 140 due to gravity as the platform 128 finds the lowest point of the curved surface 140. As a result, the platform 128 may move over, or from flush with, the sides of the ride vehicle 100 and into the ride compartment 112 in response to the movement of the ride vehicle 100.

Although ramp 136 is shown and discussed, the ride vehicle 100 may include other configurations. For example, the ride vehicle 100 may include a track or rail system that functions similar to the ramp 136. In such examples, the wheels 142 may move along the track or rail system. In some examples, the ramp 136 may include a track or rail system, such as to constrain movement of the platform 128 and/or movably secure the platform 128 to the ride vehicle 100. The wheel and track or rail configuration may allow the platform 128 to roll along the ramp 136 freely.

The platform 128 may be movable between a loading/unloading position and a ride position, such as via the tilting motion of the ride vehicle 100. In one example, the platform 128 may be configured to move between the loading/unloading position and the ride position in response to the movement of the ride vehicle 100. For example, the platform 128 may move between the loading/unloading position and the ride position based on gravity as the platform 128 finds the lowest point of the curved surface 140. FIG. 1 illustrates the platform 128 at the ride position. The ride position may be configured to locate the platform 128 within the hull 102. In one example, the ride position locates the platform 128 at or adjacent the floor 138 of the hull 102. In another example, the ride position may bias the platform 128 against a stop 148, such as passively via gravity or actively via a biasing element. The stop 148 may be defined by a wall of the ride vehicle 100. For example, the stop 148 may be defined by the front or bow wall, such that the platform 128 engages the front or bow wall to define the ride position. In some examples, the platform 128 may be locked at the ride position to limit movement of the platform 128 away from the stop 148. For example, the platform 128 may be releasably secured in the ride position.

FIG. 2 illustrates the platform 128 between the ride position and the loading/unloading position (e.g., an intermediate position). The intermediate position may locate the platform 128 along the ramp 136, such as allowing the platform 128 to move along the curved surface 140 from the ride position to the loading/unloading position, or vice-versa. In the intermediate position, the platform 128 may be positioned away from the stop 148. In the intermediate position, the platform 128 may be allowed to move freely between the ride position and the loading/unloading position.

FIG. 3 illustrates the platform 128 at the loading/unloading position. The loading/unloading position locates the platform 128 adjacent the loading/unloading platform 122. For example, the loading/unloading position may be configured to bias the platform 128 against the loading/unloading platform 122, such as passively via gravity or actively via a biasing element. Such examples may facilitate loading or unloading of the platform 128. For example, one or more gaps between the platform 128 and the loading/unloading platform 122 may be minimized to facilitate transitioning between the loading/unloading platform 122 and the platform 128. In one example, the loading/unloading position may position the platform 128 so as to define a continuous surface from the loading/unloading platform 122 to the platform 128, and vice-versa.

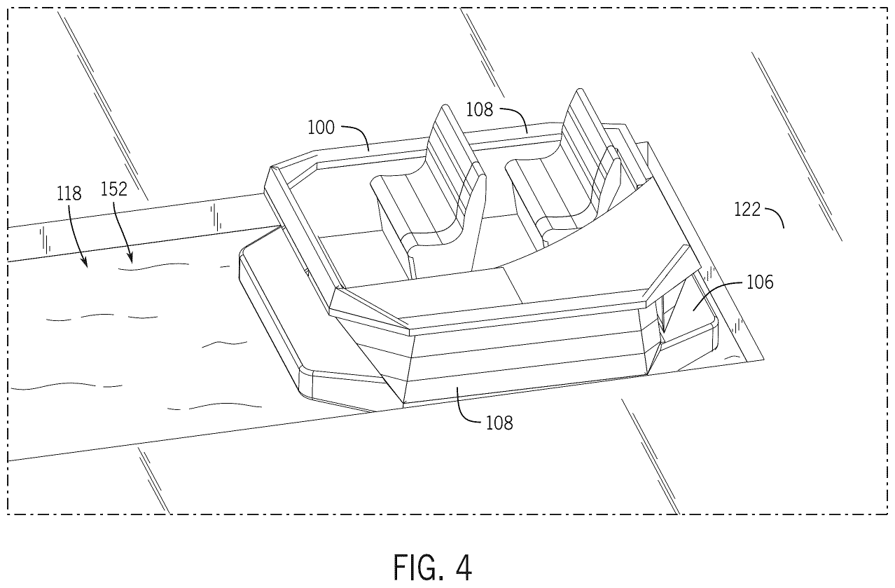

FIG. 4 illustrates the ride vehicle 100 at the loading/unloading platform 122. The pathway 118 may position the ride vehicle 100 adjacent the loading/unloading platform 122. For example, the pathway 118 may include a section 152 configured to locate the stern 106 adjacent the loading/unloading platform 122. In some examples, the section 152 may be configured to locate the gunwales 108 adjacent the loading/unloading platform 122. In such examples, one or more passengers may be loaded into the ride vehicle 100 from the sides. For example, one or more passengers may step down or up from the loading/unloading platform 122 and into the ride vehicle 100. In one example, the loading/unloading platform 122 may be fixed, with the ride vehicle 100 brought into position adjacent the loading/unloading platform 122. In another example, the loading/unloading platform 122 may be moved into position adjacent the ride vehicle 100.

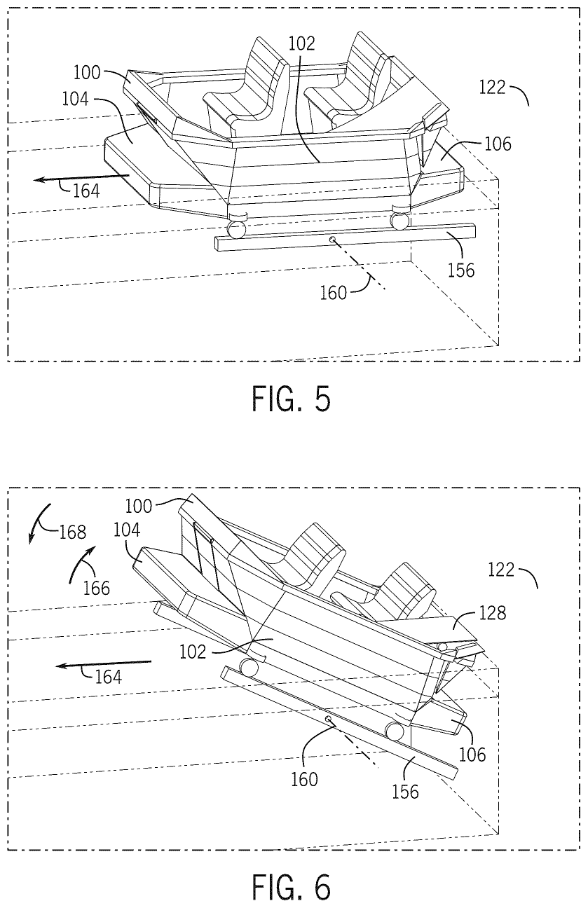

FIGS. 5-6 illustrate tilting features configured to tilt the ride vehicle 100 when the ride vehicle 100 is positioned at the loading/unloading platform 122. The system may include load rails 156. In one example, the load rails 156 may be coupled to or formed integrally with the ride vehicle 100. For example, the load rails 156 may be coupled beneath the hull 102 and positioned below the water surface. In other examples, the load rails 156 may be separate from the ride vehicle 100, with portions of the ride vehicle 100 engaging the load rails 156 when positioned at the loading/unloading platform 122. In one example, the load rails 156 may be coupled to the loading/unloading platform 122.

The load rails 156 may tilt the ride vehicle 100 about an axis 160. For example, the load rails 156 may rotate about the axis 160 to move the ride vehicle 100 between a flat position (see FIG. 5) and a tilted position (see FIG. 6). The load rails 156 may be rotated via an actuation mechanism. For example, the load rails 156 may be rotated using hydraulics, pneumatics, a motor, or another mechanical or electrical system, such as via various linkages, gears, actuators, valves, cylinders, rams, pumps, etc. In one example, the actuation mechanism may exert a force to lift the bow 104. In another example, the actuation mechanism may exert a force to lower the stern 106. With additional reference to FIG. 1, when implemented in a water ride, the flat position may position the ride vehicle 100 level with a waterline 162. With additional reference to FIGS. 2-3, the tilted position may position one portion of the ride vehicle 100 above the waterline 162 and another portion of the ride vehicle 100 below the waterline 162, while always keeping the edge or sides of the ride vehicle 100 above the waterline 162 to prevent water intrusion. For example, the tilted position may position the bow 104 above the waterline 162 and the stern 106 below the waterline 162. In other examples, the tilted position may move the ride vehicle 100 to different positions. For example, the tilted position may pitch, roll, or otherwise rotate the ride vehicle 100 from the flat position.

The platform 128 may move in response to the pitching or tilting of the ride vehicle 100 about the axis 160. For example, the platform 128 may move between the ride position and the loading/unloading position as the ride vehicle 100 is rotated about the axis 160. In one example, the ride vehicle 100 may be configured to move in a ride direction 164. The tilting or pitching motion may be a tilting or pitching of the ride vehicle 100 forwardly and rearwardly relative to the ride direction 164. For example, referring to FIG. 6, the ride vehicle 100 may be rotated about the axis 160 in a first direction 166 or a second direction 168. In one example, the first direction 166 may be a clockwise direction, and the second direction 168 may be a counterclockwise direction, in the reference frame of FIG. 6. In one example, the bow 104 of the ride vehicle 100 may be moved upward relative to the stern 106 to pitch the ride vehicle 100 to the tilted position. In another example, the stern 106 may be moved downwardly relative to the bow 104 to pitch the ride vehicle 100 to the tilted position. Conversely, the bow 104 of the ride vehicle 100 may be moved downward relative to the stern 106 to pitch the ride vehicle 100 to the flat position. In another example, the stern 106 may be moved upwardly relative to the bow 104 to pitch the ride vehicle to the flat position. In some examples, the ride vehicle 100 may be secured in either the flat position of FIG. 5 or the tilted position of FIG. 6, such as to prevent movement of the ride vehicle 100 during passenger loading.

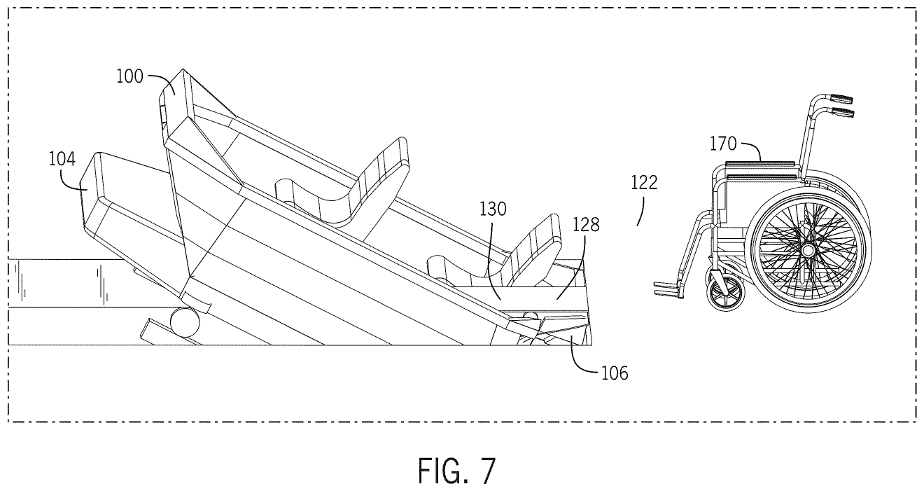

FIG. 7 illustrates the ride vehicle 100 in a first position and ready to receive an object 170 on the platform 128. The first position may be the tilted position described with reference to FIG. 6. For example, the first position may be defined by the bow 104 moved upwardly relative to the stern 106 to pitch the ride vehicle 100 upwardly or rearwardly (e.g., in first direction 166). In the first position, the stern 106 may be moved below the surface of the loading/unloading platform 122, allowing the platform 128 to be positioned adjacent the loading/unloading platform 122. In the first position, the object 170 may be moved from the loading/unloading platform 122 to the platform 128, and vice-versa. For example, the first position may locate the platform 128 adjacent the loading/unloading platform 122 for moving the object 170 on the planar surface 130. In one example, the surfaces of the loading/unloading platform 122 and the platform 128 may be coplanar or generally coplanar to facilitate a transition between the loading/unloading platform 122 and the platform 128.

The object 170 may be a wheelchair, a scooter, an electric scooter, a walker, a stroller, a prop, an animatronic, a maintenance cart or equipment, or another object (shown as a wheelchair for illustration purposes only, without intent to limit). In one example, the object 170 may be anything with wheels for maneuverability onto the platform 128. In another example, the object 170 may be an item without wheels. In another example, the object 170 may be a person with limited mobility or otherwise needs assistance to enter the ride vehicle 100 without stepping over the sides. Thus, the object 170 is not limited to any particular item or person.

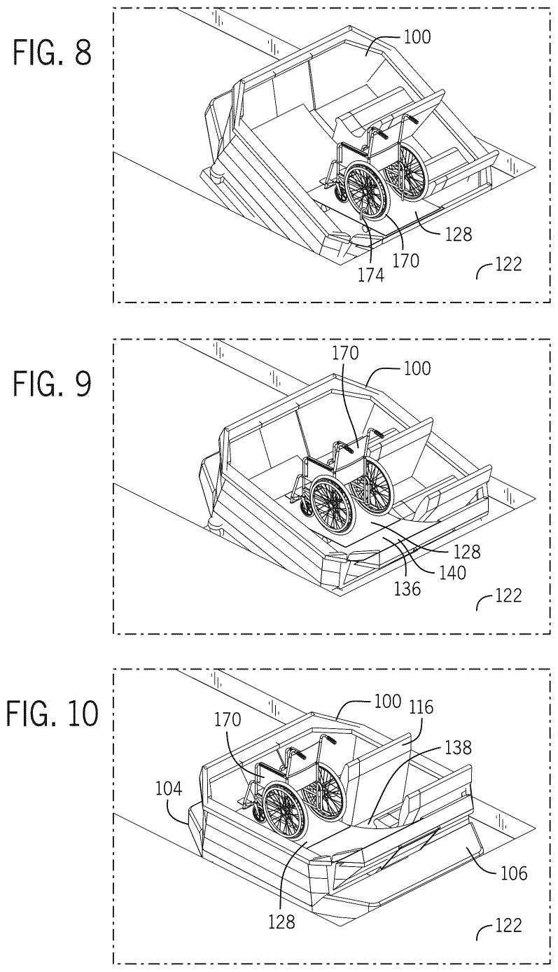

FIG. 8 illustrates the ride vehicle 100 in the first position and the object 170 positioned on the platform 128. The object 170 may be rolled, slid, driven, moved, or otherwise placed from the loading/unloading platform 122 and onto the platform 128. Once in position, the object 170 may be secured in place. For example, the platform 128 may include securement features 174 configured to engage the object 170 to secure the object 170 on the platform 128. The securement features 174 may include straps, buckles, locks, hooks, corresponding engagement elements, or other features to hold the object 170 in place. In some examples, the platform 128 may include alignment features. The alignment features may orient the object 170 on the platform 128. For example, the platform 128 may include grooves, tracks, or rails to at least partially define the position of the object 170 on the platform 128, such as by receiving a wheel or other portion of the object within a groove, track, or rail.

FIG. 9 illustrates the ride vehicle 100 tilting forward to a second position with the platform 128 moving away from the loading/unloading platform 122. As the ride vehicle 100 tilts forward away from the loading/unloading platform 122, for example, as the ride vehicle 100 pitches in the second direction 168, the platform 128 may move along the ramp 136. For example, the platform 128 may move along the curved surface 140 via gravity as the platform 128 finds the lowest point of the ramp 136. In another example, the platform 128 may be moved actively. For example, the platform 128 may be moved using pneumatics or hydraulics or via a motor and gear train. Regardless of the motive force, the platform 128 may move along the ramp 136 to transport the object 170 in a flat orientation. For example, the platform 128 may be moved to maintain the planar surface 130 parallel or generally parallel to the loading/unloading platform 122.

FIG. 10 illustrates the ride vehicle 100 tilted forward with respect to FIG. 9 to a third position with the platform 128 at the ride position. In one example, the third position may be the flat position described with reference to FIG. 5. In another example, the third position may be the ride position described with reference to FIG. 1. For example, the third position may be defined by the bow 104 moved downwardly relative to the stern 106 to pitch the ride vehicle 100 downwardly or forwardly. In the third position, the stern 106 may be moved above the surface of the loading/unloading platform 122. The third position may locate the platform 128 adjacent the bow 104. The third position may locate the object 170 within the ride vehicle 100. In one example, the third position may locate the platform 128 in a ride position. In another example, the third position may locate the object 170 level with the seats 116. In another example, the third position may locate the object 170 at or adjacent the floor 138. For example, the third position may locate the platform 128 coplanar or generally coplanar with the floor 138 supporting the seats 116. In another example, the third position may locate the platform 128 slightly elevated from the floor 138.

Referring to FIGS. 8-10, the platform 128 may move in response to the tilting or pitching motion of the ride vehicle 100 to transport the object 170 in a flat orientation. For example, the platform 128 may move between the bow 104 and the stern 106 as the ride vehicle 100 rotates underneath the platform 128. In this manner, the platform 128 may act similar to a gimbal to maintain the object 170 level as the ride vehicle 100 moves, such as between the loading/unloading and ride positions. In some examples, the platform 128 may move linearly in response to the pitching of the ride vehicle 100. For example, the platform 128 may move forward and back between the bow 104 and the stern 106, such as level with the water surface or loading/unloading platform 122 as the ride vehicle 100 pitches between the loading/unloading and ride positions.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A ride vehicle comprising:
a movable platform configured to receive an object;
wherein the movable platform is configured to move in response to a tilting motion of the ride vehicle to transport the object on the moveable platform in a flat orientation with respect to a water or ground surface.

2. The ride vehicle of claim 1, further comprising a curved surface, wherein the movable platform is configured to move along the curved surface in response to the tilting motion of the ride vehicle.

3. The ride vehicle of claim 2, wherein the movable platform comprises a planar surface, and wherein the curved surface is configured to maintain the planar surface in the flat orientation during the tilting motion of the ride vehicle.

4. The ride vehicle of claim 1, wherein:
the tilting motion is configured to move the movable platform between a loading/unloading position and a ride position;
the loading/unloading position is configured to locate the movable platform adjacent a loading/unloading platform for moving the object on and off the movable platform; and
the ride position is configured to locate the movable platform and the object thereon within the ride vehicle.

5. The ride vehicle of claim 4, wherein the movable platform is releasably secured in the ride position.

6. The ride vehicle of claim 4, further comprising one or more seats, wherein the ride position is configured to locate the movable platform to cause the object to be level with the one or more seats.

7. The ride vehicle of claim 1, wherein the ride vehicle is configured to move in a ride direction, and wherein the tilting motion is a tilting of the ride vehicle at least one of forwardly or rearwardly relative to the ride direction.

8. The ride vehicle of claim 1, wherein the movable platform comprises securement features configured to engage the object to secure the object on the movable platform.

9. The ride vehicle of claim 1, wherein the object is a wheelchair, an electric scooter, or a stroller.

10. The ride vehicle of claim 1, wherein the ride vehicle is a water vehicle.

11. A vehicle comprising:
a platform forming a load surface configured to receive an object,
wherein the platform is configured to move in response to a movement of the vehicle to maintain the platform in a flat orientation with respect to a water or ground surface.

12. The vehicle of claim 11, wherein the movement comprises a pitching of the vehicle about an axis.

13. The vehicle of claim 12, wherein the platform is configured to move linearly in response to the pitching of the vehicle.

14. The vehicle of claim 11, further comprising fixed sides defining a ride compartment, wherein the platform is configured to move the object over at least one of the fixed sides and into the ride compartment in response to the movement of the vehicle.

15. The vehicle of claim 11, further comprising a ramp and one or more wheels configured to move the platform along the ramp.

16. The vehicle of claim 15, wherein the ramp comprises a curved surface, and wherein the one or more wheels are positioned to move along the curved surface.

17. The vehicle of claim 11, wherein the platform is configured to move between a loading/unloading position and a ride position in response to the movement of the vehicle, and wherein the platform is configured to move between the loading/unloading position and the ride position based on gravity.

18. The vehicle of claim 17, further comprising a floor, wherein the ride position is configured to locate the object at or adjacent the floor.

19. The vehicle of claim 17, wherein the loading/unloading position is configured to bias the platform against a loading/unloading platform.

20. The vehicle of claim 11, wherein the vehicle is a ride vehicle for an attraction.
